(19) United States
(12) Patent Application Publication
(10) Pub. No.: US 2002/0122045 A1
(43) Pub. Date: Sep. 5, 2002

(54) FONT ANTI-ALIASING SYSTEM

(76) Inventors: MORGAN WOODSON, SANTA CRUZ, CA (US); DENNIS FLEMING, BELMONT, CA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/216,676

(22) Filed: Dec. 19, 1998

(51) Int. Cl. G09G 5/00; G06T 5/00; G06T 11/00; G06K 9/40

(52) U.S. Cl. 345/611; 345/471; 382/269; 345/947; 345/606; 345/472

(57) ABSTRACT

A method and apparatus for creating anti-aliased fonts for display on a graphics display comprising analyzing a subject font, calculating at least one alpha value to determine the translucency of the subject font edges, incorporating the alpha value in the subject font bit information, and rendering the subject font with translucent edges.

### BACKGROUND OF THE INVENTION

The present invention relates generally to techniques for interpolating pixel values in a computer graphics display. More particularly, the present invention provides an efficient method for softening or “fuzzying” the edges of a font on a graphics display.

Information service to the home is a new field, enabled by the availability of storage and transmission technologies that can store and deliver data such as video and images at an affordable cost. The once separate domains of television, computers, communications, and entertainment are currently melding to form a new marketplace for interactive television.

A variety of players populate the emerging interactive television market. Authoring tool developers provide environments for creating multimedia products that consumers utilize. Developers use these and other tools to create multimedia content. Broadcasters and interactive content providers market these products and other media across broadcast networks. Manufacturers provide the hardware, and operating system developers provide the software that allows consumers to take advantage of these products and services from their home televisions and multimedia systems.

In the new home multimedia systems, an encoded television signal is usually decoded and formatted for display on a television screen by a device commonly referred to as a “set-top terminal” or “box.” Interactive digital set-top terminals provide an open platform for developing and delivering interactive services and multimedia content to consumers across a broadcast network. Such set-top terminals are equipped with numerous abilities including the ability to display letters or fonts as messages overlaid or superimposed on a television screen.

The set-top terminal performance is restricted by requirements such as the management of high data throughput, limited memory in a constrained consumer device, and support for a secure environment drive. These requirements drive the decision to architect an innovative operating system for use in set-top terminals to optimize the network and processing capabilities of a digital set-top terminal support, ensuring a broad range applications and services are provided.

When used for displaying fonts, set-top terminals generally format the graphics according to one or more video display standards, such as 320×240 pixels, 640×480 pixels, or 1024×1024 pixels. The use of medium resolution display image (e.g. 320×240 pixels) increases graphics performance and reduces memory requirement for video games and other high performance applications which require substantial pixel manipulation, because fewer pixels must be manipulated and stored.

Conventional computer graphics displays often include the ability to overlay an image or font onto background video. For example, sports scores or messages may be superimposed at the bottom of a moving image of a football game. In such systems, each pixel can be rendered in one of three ways: opaque (every pixel takes on the value of the overlaid image only); translucent (the overlaid image and background image can be blended so that the background image can be “seen through” the overlay); or as transparent (only the background image is displayed). As another example, a graphical control object such as volume control indicator may be superimposed over a live video image on a television display.

In today's video display technology, fonts displayed on graphics displays have edges which may appear jagged or too crisp. In certain video formats such as NTSC, the horizontal lines will appear to shake, skewing the appearance of displayed fonts. A prior solution to this problem was to blend the edges of the fonts into adjacent graphics through the manipulation of the font's color. This method requires an inordinate amount of memory, and rendering the fonts can be time consuming, leading to a sluggish appearance for screen updates. This method is more CPU intensive than bitmapped fonts and the addition of an alpha value will only decrease performance.

In order to control the amount of color blending in the aforementioned examples, conventional systems typically allocate a plurality of additional bits for each pixel which indicate the degree to which the pixels from the overlay and the background will be blended. For example, a group of such “blending” bits for each pixel can be multiplied with the overlay pixel value before being combined with the background image, thus controlling whether the overlay portion or the background image will dominate the resultant image.

### SUMMARY OF THE INVENTION

The present invention solves the aforementioned problems by providing a low cost, low overhead technique for accommodating so-called alpha “blending bits” for improving the appearance of displayed fonts. The alpha blending bits will contain information changing the translucency of the font layout and not the color averaging used in the prior art. For example, the center of the font will normally be less translucent then the edges of the font, creating indistinct or fuzzy edges. The invention interpolates pixel values horizontally and vertically using a pixel replication and shifting scheme and interpolates not only the pixel values but also the alpha blending argument values. The font edge translucency will effectively smooth the edges of the font to a viewer, removing unwanted crispness and jaggedness.

The present invention can be used in any system having a graphics display such as an interactive TV system, personal computer, video game machine, or titling machine used in video production. The specific embodiments of the present invention will be described in the context of interactive television systems and set-top terminals.

Further objects, features, and advantages of the invention will become apparent from a consideration of the following description and the appended claims when taken in connection with the accompanying drawings.

### BRIEF DESCRIPTION OF THE DRAWINGS

FIG. 1 depicts the hardware architecture utilized by the set top terminal of the present invention;

FIG. 2 depicts the basic software components of the operating system utilized by the set-top terminal in accordance with the present invention;

FIG. 3 illustrates the display of a font within a pixel map;

FIG. 4 illustrates the differences between anti-aliased fonts and normal fonts;

FIG. 5 is another illustration of an anti-aliased font; and

FIG. 6 depicts alpha values and their corresponding translucency shades.

### DETAILED DESCRIPTION

The following description of the present invention is merely exemplary in nature and is in no way intended to limit the invention or its uses. Moreover, the following description, while depicting an operating system designed to reside on a conventional set-top terminal, is intended to adequately teach one skilled in the art to make and use an operating system for a variety of consumer multimedia clients including, but not limited to, intelligent televisions, Internet terminals and advanced DVD players.

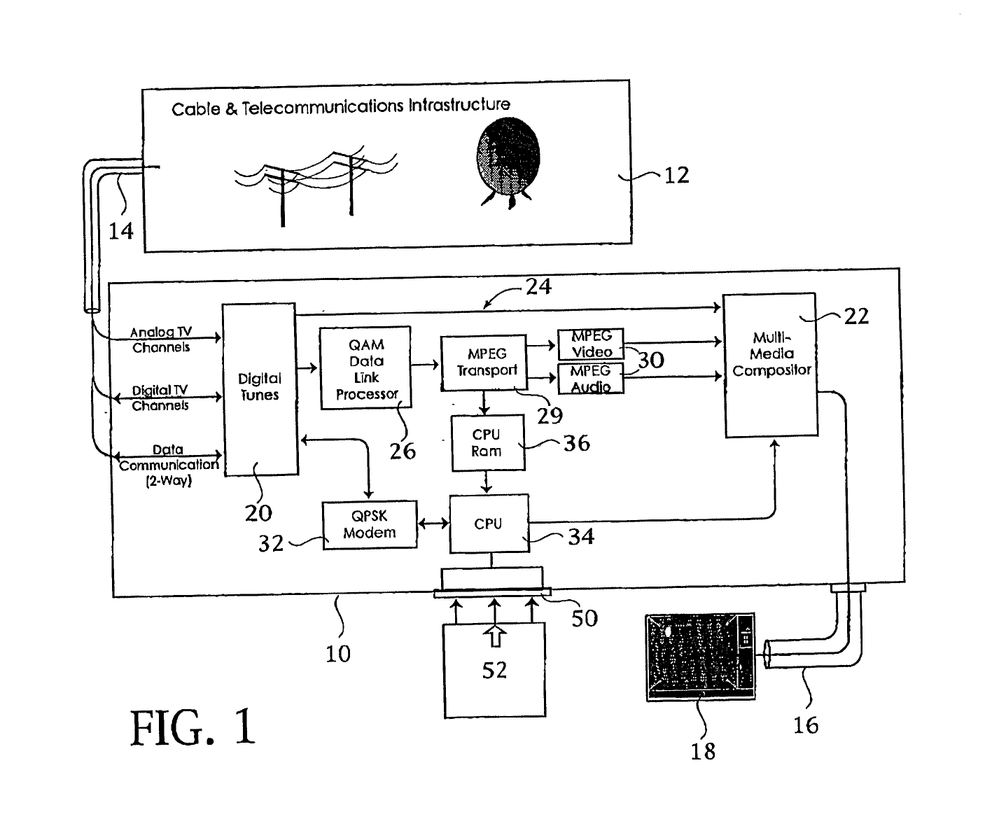

The anti-aliasing font engine of the invention is preferably embedded as a component in a computer operating system residing in a set-top terminal, as will be described more fully below. Although the anti-aliasing font engine is not limited to the set-top terminal environment, it is useful in that environment. Accordingly, FIG. 1 illustrates the basic components of a digital set-top terminal. A basic understanding of the set-top terminal may be helpful in understanding the anti-aliasing font engine of the invention.

Referring to FIG. 1, the set-top terminal 10 is coupled to the cable and telecommunications infrastructure 12 through a suitable cable 14. The set-top terminal is also coupled through a second cable 16 to the television set 18. Communication between the telecommunications infrastructure 12 and the set-top terminal 10 establishes a variety of communications and program options available to the subscriber for interactive control and participation in a way the licensing and charging is easily administered.

The incoming cable 14 may support a plurality of different channels. For purposes of illustration, cable 14 has been shown as supplying three different logical channels: (a) a set of analog TV channels, (b) a set of digital TV channels and (c) a set of data communication channels. It will be appreciated that these are logical channel constructs; all three sets of channels are typically carried on the same physical wire or fiber-optic cable. Thus the three separate channels shown in FIG. 1 are for illustration purposes only.

Conventionally, the analog and digital TV channels support one-way communication, from the cable and telecommunications infrastructure 12 to the digital tuner 20. The data communication channels are two-way channels, supporting bi-directional communication between the infrastructure 12 and the tuner 20.

The various sets of channels supplied via cable 14 are distinguished by frequency. Digital tuner 20 selects which frequency, and thus to which channel, the set-top terminal is tuned. Analog TV channels are sent directly from tuner 20 to the multimedia compositor circuit 22. The compositor circuit formulates the RF signal supplied through cable 16 to the television 18. Typically the television is tuned to a pre-assigned channel to properly receive the RF signal from compositor 22.

Digital TV channels are also sent to compositor 22, although they are first processed through the additional circuitry illustrated at 24. Specifically, the digital TV signal is first processed through the quadrature amplitude modulated (QAM) data link processor 26 and then by the MPEG transport circuitry 29. The transport circuitry extracts the desired digital TV program from the transport stream. It then separates the audio, video and data components, which are routed to the video and audio decoders 30 and to the CPU ram 36. MPEG video and MPEG audio are then separately processed by the circuitry 30.

Data communication, including control signals for messaging are separately processed through the quaternary phase shift keying (QPSK) modem 32. The modem is coupled to the central processing unit (CPU) 34, which has associated CPU RAM 36. In an interactive digital environment, QPSK channels provide transparent two-way communications between the user and the content provider. Database queries to content providers travel over these channels to provide users with a choice of interactive entertainment options. While applications are running, these channels transmit user commands, such as play video, pause, or fast-forward, to the content source. They also allow for the request and delivery of graphics, fonts and other data and support purchasing of goods and services.

The multimedia compositor 22 generates a display image from video and audio input streams and from CPU-generated media. It combines graphics and text, generated by applications running in the digital set-top terminal, with full motion MPEG-2 or analog video. The composition of graphics and video includes translucent alpha-blending of the two, scaling of motion video into a window, and the overlay of graphics and video. There are various bit encoding schemes used for computers and graphics peripherals for the storage of color and brightness information. The peripheral repeatedly reads a portion of a main computer memory or memory attached to the peripheral, interpreting stored values as colors and brightness, creating a stream that is interpreted by a multimedia compositor 22.

Two bit encoding schemes will be addressed in this application, however the present invention is intended to be applied to any similar encoding schemes. RGB565 is a bit encoding scheme which utilizes 16 bits for every pixel (picture element-a display screen is made up of a two dimensional array of pixels). The bits are assigned as follows: 5 bits are used for the red level, 6 for the green level, and 5 for the blue level. A value of 0 means no light or color should be emitted and the maximum value (31 for red or blue and 63 for green) means the maximum level should be emitted. Black has a value of 0 and white is 0xffff (hexadecimal or 65,535 base 10). Pure red is 1111100000000000 (0xf800 hex). ACLUT88 is similar to RGB565 with additional bits used for precision. In ACLUT88, 8 bits are used to look up the actual color in a table. The other 8 bits are used for an alpha value for blending the graphics with some other content (such as motion video for television). A value of 128 signifies a completely opaque pixel. A value of 64 is a 50/50 blend and 0 means that the graphics are completely translucent.

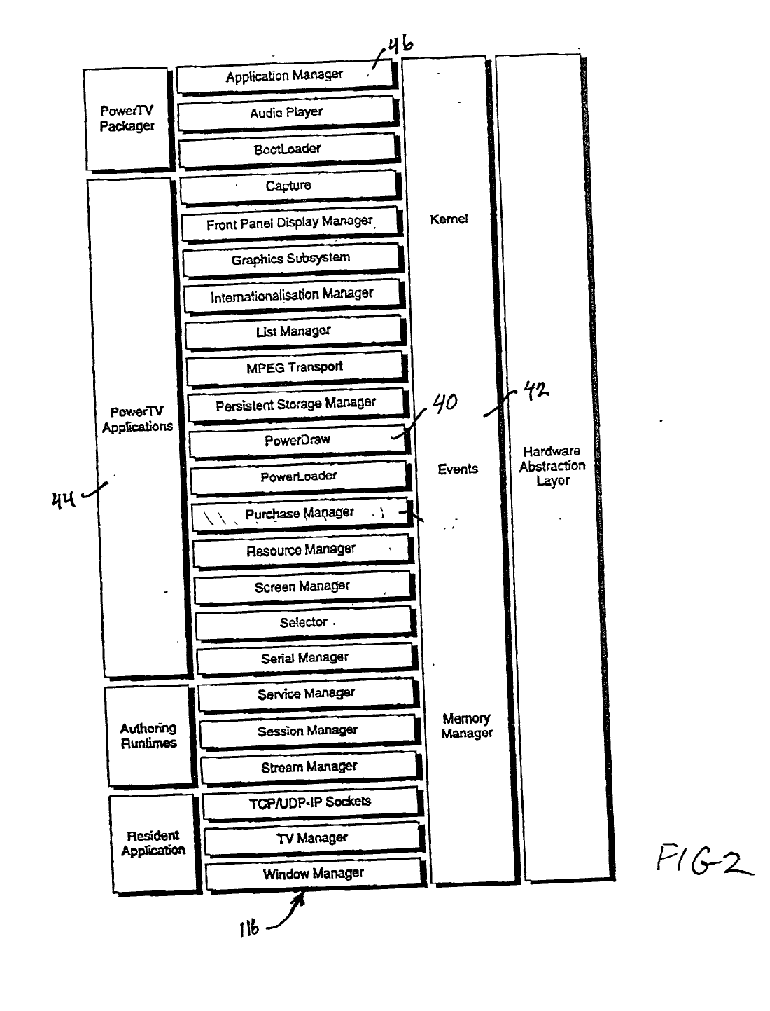

The presently preferred set-top terminal is bundled with an operating system whose architecture is illustrated in FIG. 2. Specifically, FIG. 2 provides a high-level view of the operating system components. The operating system consists of layers of interconnected software modules designed to minimize redundancy and optimize multimedia processing in a set-top terminal environment. Each module executes specific tasks concerning the interpretation, transmission, and display of video and audio information as well as other types of digital or analog information. The multitasking operating system is designed to address the high-performance demands of media-centric, real-time applications being delivered through a set-top terminal. The operating system provides an open, scalable platform for developing and delivering multimedia content to consumers across broadcast and client/server networks. The software architecture for the operating system is comprised of layers of interconnected modules designed to minimize redundancy and optimize multimedia processing in an interactive, network setting.

A kernel and memory manager residing in the core layer 42 provide the base functionality needed to support an application. A fully preemptive, multithreaded, multitasking kernel is designed to optimize both set-top memory footprint and processing speed. Since the operating system will reside on consumer units, it has been designed to exist in a ROM-based system with a very small footprint (e.g., 1 MB). in addition, the kernel has also been created to take advantage of 32-bit Reduced Instruction Set Computer (RISC) processors which enable high-speed transmission, manipulation and display of complex media types. On the other hand, a memory manager provides an efficient allocation scheme to enable the best performance from limited memory resources. Because embedded processors are likely to be the mainstay of consumer digital hardware implementations, the memory model requires little memory management unit support. The core layer 42 also provides an integrated event system and a standard set of ANSI C utility functions.

Built on top of the core layer 42 is an application support layer 116. This set of support modules provides higher-level processing functions and application services. Application management, session management, and tuner management are a few examples of these services. At the highest application level 44, at least one application, referred to as a resident application is always executing on a set-top terminal. The application level also provides the necessary capabilities for authoring applications and for managing resources (e.g., the tuner) between the resident application and other background applications residing on the set-top terminal.

The applications 44 are launched by the application manager 46 and thereafter provide various user interactivity functions. Examples of applications 44 include on-screen TV guide services, interactive advertising services, goods and services purchasing services, internet web browsing and e-mail services, and the like. Although applications can be loaded and run within the CPU RAM 36 (FIG. 1) they may also be resident on smartcards that are plugged into the set-top terminal to provide additional functionality. In this regard, the set-top terminal may be provided with a suitable card interface jack 50 for receiving a suitable credit card or smartcard 52.

Pertinent to the present invention is the font anti-aliasing engine that may be implemented as part of the power draw component 40 that provides 2D imaging services and graphics primitives used by the set of applications 44 running on the operating system.

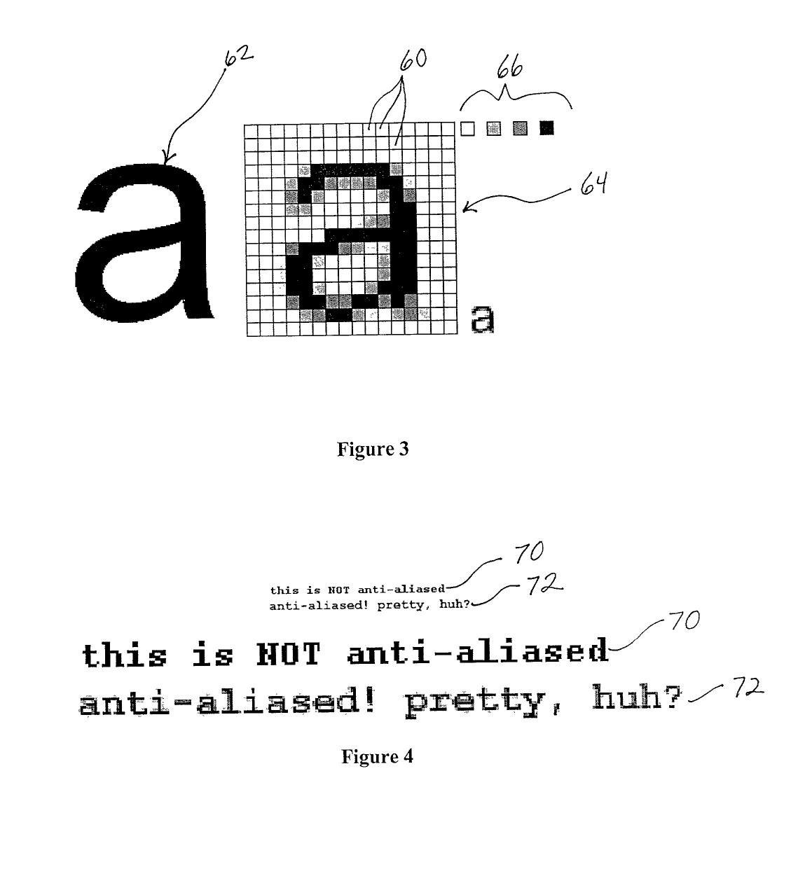

FIG. 3 shows an idealized font 62 and the actual displayed or reduced font 64 represented by a plurality of pixels 60. The reduced font 64 is comprised of pixels with varying translucency as shown by translucency scale 66. The translucency scale 66 is only exemplary as the number of translucency levels is determined by the number of bits allocated for the translucency level calculations. For example if there are 3 bits allocated for the calculation of translucency levels there will be 2³=8 translucency levels. Similarly, with 8 bits allocated for the calculations of translucency levels there will be 2⁸=256 translucency levels.

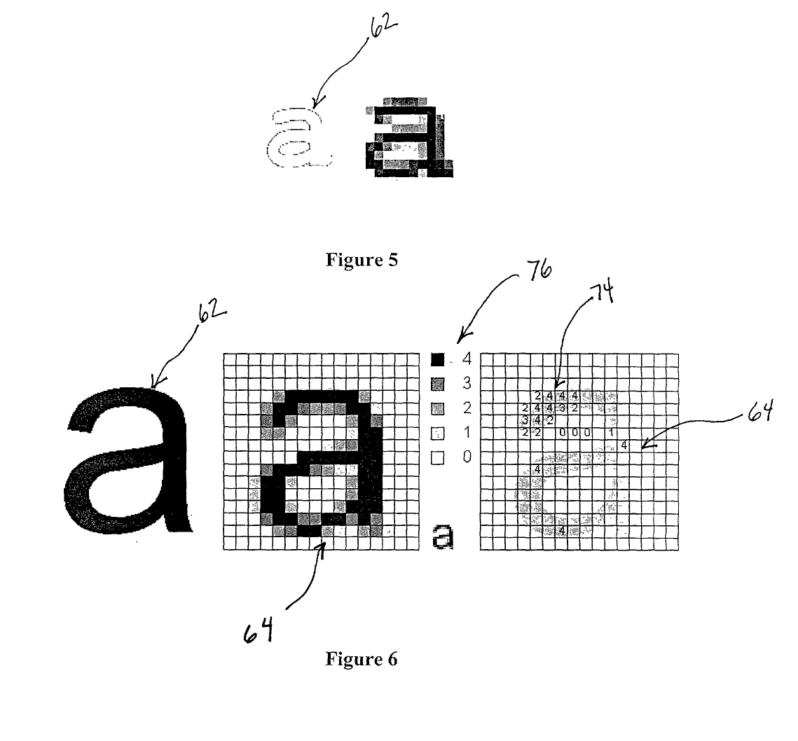

As can be seen in FIGS. 3 and 5, the interior of the font is generally darker and the edges of the font are generally more translucent. This will give the font “fuzzy” edges which improves the appearance of the font by eliminating jaggy edges. Referring to FIG. 4, sample text 70 is provided without anti-aliasing and sample text 72 is provided with anti-aliasing. Sample text 70 and 72 are shown in their normal size and a magnified size. The appearance of anti-aliased text 72 is superior to that of sample text 70 and true to the intended shape of the fonts. Anti-aliased text 72 has eliminated the jaggy edges and improved the aesthetics of the displayed fonts.

There are two common ways to store fonts: as outlines using some sort of mathematical descriptions of curves or as arrays of pixel values (bitmaps) for a font of a particular size. Outline fonts can be rendered at various sizes without inducing jagginess (as you would see if a small bitmap was scaled to a larger size), but the rendering is cpu intensive. Bitmap fonts are rendered by simply looking up pixel values from the font bitmap and writing appropriate colors to the screen's frame buffered memory. Anti-aliasing is done when outline fonts are rendered to a particular size this can be quiet CPU intensive and is hard to do without a floating point accelerator. Instead fonts can be anti-aliased during product development.

The most common implementations of bitmap fonts use 1 bit per pixel. In 1 bit per pixel schemes (1 bpp), for every pixel on the screen, the corresponding pixel in the font bitmap is looked up. If the pixel is a 1, the “foreground” color is written (black for black text on a white background). If the pixel is 0, either nothing is done or a background color is written (white in this example)

The concept is extended by using more bits per pixel to represent values between fully foreground and fully background. In the previous figures, 5 levels are used: black white and 3 grays. In real applications, 16 levels or values (4 bits per pixel) is a good compromise between image fidelity and font size (every extra bit per pixel appears in every pixel in the bitmapped font, so a 4 bpp font that takes 20 kilobytes would take 25 kilobytes at 5 bpp). The numerical values or alpha (a) values associated with each pixel will indicate the degree of translucency. The additional 16 values determines the translucency with the color specified at 24 bits RGB globally for the whole string. To render the fonts, the character cell is scanned, individual pixels are extracted, the 4 bit alpha value is scaled to a 7.5 bit value (0-128) by a scaling module and combined with the color bits to form a 32 bit RGB value which is written to a specially formed address to an “XY random” register in an ASIC (PowerTV Eagle or descendant chip in the present invention). The address is formed by combining the x and y coordinates to form an address and reserving the entire range of these addresses for this purpose only. For instance, if x and y are limited to 10 bits, a 20 bit address is formed, stealing 1 megabyte from the control processor's memory space. In the case of the POWERTV EAGLE processor, the space is 4 megabytes because the two LSB's cannot be used since all addressing is 32 bits long. The base address for the top-left corner of the string and the pitch (distance in bytes from a pixel to the one located directly below it) are set up in advance.

Referring to FIG. 6, the pixel map 70 shows the gray scale 76 and the pixel map 74 shows the alpha values 74 associated with the scaling. The lower alpha values represent pixels with higher translucency and the higher values represent pixels with lower translucency. The edges of the rendered font 64 are generally shown with lower alpha values then the interior of the rendered font 64. A generally increasing translucency gradient will exist from the center of the rendered font 64 to the edge of the rendered font 64. This change in translucency will blur or fuzzy the edges of the rendered font 64 improving its appearance and eliminating the jagged edges seen in high resolution displays.

For RGB565 graphics these alpha values 74 are used as a blend value between the given foreground color and the existing pixels. The values are calculated as follows:

New Pixel Value Old Value×(1-alpha)+foreground color×(alpha)

where alpha is the number looked up in the font bitmap scaled against it's maximum value. That is a 5 is 5/5 or 1 becomes 1/5 or 20% of foreground color plus 80% of the existing pixel's color.

For ACLUT88, the hardware will conduct blending in real time between the graphics plane and underlying video so the alpha value is scaled from the font bitmap to the range used by the hardware (from 0-15 for a 4 bpp font to 0-128 for POWERTV EAGLE and MAC chips' blender).

It is to be understood that the invention is not limited to the exact construction illustrated and described above, but that various changes and modifications may be made without departing from the spirit and scope of the invention as defined in the following claims.

I claim:

1. A method of displaying fonts on a graphics display comprising the steps of:
scanning a stream of pixels which represent a font;
extracting individual pixels;
scaling an alpha value containing translucency information; and
combining said alpha value with said stream of pixels, wherein said alpha value will change the translucency of said individual pixels to make the edges of said font appear fuzzy.

2. The method of claim 1, wherein said alpha value comprises 4 bits.

3. The method of claim 1, further comprising the step of displaying said individual pixels on said graphics display.

4. The method of claim 1, wherein the translucency of said font generally follows a gradient from the center of said font to said edges of said font.

5. The method of claim 4, wherein said gradient increases from said center of said font to said edges of said font.

6. The method of claim 1, wherein said font further includes a 24 bit value containing color information.

7. The method of claim 6, wherein said alpha value is a 4 bit value scalable to a 7.5 bit value, and wherein said 7.5 bit value is combined with said 24 color information to form a 32 bit RGB value.

8. The method of claim 7, wherein said 32 bit value is written to an address, said address formed by combining the x and y coordinates.

9. An anti-aliasing font engine operating within a set-top terminal operating system comprising:
a scanner for scanning a font;
an extractor for extracting individual pixels from said font;
an analyzer for determining the desired translucency levels of said individual pixels and storing said desired translucency levels in an alpha value, wherein said alpha value is combined with a font string containing color information for said font to create a RGB value, and wherein said font may be displayed on a graphics device with a translucency gradient, fuzzying the edges of said font.

10. The anti-aliasing font engine of claim 9, wherein said alpha value is a 4 bit value.

11. The anti-aliasing font engine of claim 9, wherein said translucency gradient increases from the center of said font to the edge of said font.

12. The anti-aliasing font engine of claim 9, wherein said font string comprises a 24 bit RGB value.

13. The anti-aliasing font of claim 9, wherein said RGB value is stored in an address formed by combining the x and y coordinates.

14. A method of anti-aliasing fonts for display on a television comprising:
analyzing a subject font;
calculating at least one alpha value to determine the translucency of said subject font edges;
incorporating said alpha value in said subject font bit information; and
rendering said subject font with translucent edges determined by said alpha value.

15. The method of claim 14, further comprising the step of creating an increasing translucency gradient from the center of said subject font to said subject font edges.

16. The method of claim 14, further comprising the step of displaying said subject font on a graphics display.
